(19) United States
(12) Patent Application Publication
(10) Pub. No.: US 2003/0051186 A1
(43) Pub. Date: Mar. 13, 2003

(54) Methods to restore tests execution after unexpected crashes for use in a distributed test framework

(75) Inventors: Konstantin I. Boudnik, Santa Clara, CA (US); Weiqiang Zhang, San Jose, CA (US)

Correspondence Address: MARTINE & PENILLA, LLP, 710 LAKEWAY DRIVE, SUITE 170, SUNNYVALE, CA, 94085, US

(73) Assignee: Sun Microsystems, Inc., Palo Alto, CA (US)

(21) Appl. No.: 09/995,041

(22) Filed: Nov. 26, 2001

Related U.S. Application Data
(63) Continuation-in-part of application No. 09/953,223, filed on Sep. 11, 2001.

(51) Int. Cl. H02H 3/05; G06F 9/44

(52) U.S. Cl. 714/2; 717/124

(57) ABSTRACT

An invention is provided for restoring execution of an application program after interruption in a distributed processing framework. The invention includes a post mortem object that stores point of execution information for an application program. The point of execution information is periodically updated to reflect a current point of execution within the application program at a time of the update. In addition, an agent process is included that executes on a processing resource, such as a test system. The agent process is capable of utilizing the post mortem object to reinitialize the application program to begin execution from a position described by the point of execution information.

### CROSS REFERENCE TO RELATED APPLICATIONS

This application is a continuation-in-part of U.S. patent application Ser. No. 09/953,223, filed Sep. 11, 2001, and entitled “Distributed Processing Framework System,” which is incorporated herein by reference. This application is also related to U.S. application Ser. No. ______ (Attorney Docket No. SUNMP030), filed Nov. 20, 2001, and entitled “Methods to Develop Remote Applications with Built in Feedback Ability for Use in a Distributed Test Framework,” which is incorporated herein by reference.

### BACKGROUND OF THE INVENTION

1. Field of the Invention

The present invention relates generally to network software testing, and more particularly, to methods and systems for restoring test execution after an unexpected crash in a distributed test framework.

2. Description of the Related Art

As the use of software in performing daily tasks is increasing rapidly, assessing software reliability through software testing has become an imperative stage in software development cycle. As is well known, software testing is used to find and eliminate defects (i.e., bugs) in software, which if undetected, can cause the software to operate improperly. In general, a stand-alone computer or a network of computer resources can perform software testing. When a stand-alone computer system is used to perform the software testing, the computer system is programmed to run a test selected by the software user. Comparatively, if a network of computer resources is used, the user is responsible for manually adding and deleting the computer resources to the network, programming the master computer system and the server, initiating the running of a user-selected test, and running the test on the group of dedicated computer systems coupled to the server.

In either scenario, a heavy user interface is required for initiating the software testing on the master computer, scheduling the running of the specific test on the system resources, adding and deleting of the system resources, keeping track of the system resources and their respective hardware and software configuration, and maintaining the system resources. Also, in either case, dedicated system resources perform the software testing. That is, the system resources are designed to be solely used for software testing.

Further, when operating a network of computer resources, crashes can occur on particular computer resources. However, recovery from crashes using a conventional computer network typically involves manual operations, which are both labor intensive and error prone. For example, when executing a test suite, which typically comprises a plurality of individual tests, recovery from a crash of the test suite often requires examining several hundred individual test results to determine which tests have not been executed. Thereafter, a test engineer generally can restart the test suite execution from the point of the crash. However, the manual examination of the individual test results is a labor intensive process that is prone to human error.

In view of the foregoing, there is a need for a flexible methodology and system capable of selecting and utilizing dynamic, cross-platform computer resources to process a computer software. Further, the system should be capable of providing an ability to restore remote test execution from the point of interruption in an automatic or semi-automatic manner.

### SUMMARY OF THE INVENTION

Broadly speaking, the present invention fills these needs by providing an ability to restore remote test execution from the point of interruption. As a result, a user can restart the execution of a test suite from the point where a crash has occurred. In one embodiment, a system for restoring execution of an application program after interruption in a distributed processing framework is disclosed. The system includes a post mortem object that stores point of execution information for an application program. The point of execution information is periodically updated to reflect a current point of execution within the application program at a time of the update. In addition, the system includes an agent process that executes on a processing resource, such as a test system. The agent process is capable of utilizing the post mortem object to reinitialize the application program to begin execution from a position described by the point of execution information.

In another embodiment, a method is disclosed for restoring execution of an application program after interruption in a distributed processing framework. An agent process is provided, which is in communication with an application program. The agent process updates a post mortem object based on the current point of execution within the application program. In this manner, the application program can be reinitialized after interruption utilizing the post mortem object.

A computer program embodied on a computer readable medium for restoring execution of an application program after interruption in a distributed processing framework is disclosed in a further embodiment of the present invention. The computer program includes a code segment that receives execution information from an application program. As above, the execution information includes a current point of execution within the application program. In addition, a code segment is included that updates a post mortem object based on the execution information. The computer program also includes a code segment that reinitializes the application program utilizing the post mortem object after interruption of the application program. Other aspects of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram illustrating a distributed test framework (DTF) system, in accordance with one embodiment of the present invention;

FIG. 2 is a block diagram illustrating the capability of the present invention to intelligently locate an available and suitable test system to execute a test suite, in accordance with another embodiment of the present invention;

FIG. 3 is a block diagram illustrating the implementation of the test system attributes to locate a suitable test system to process a test execution request, in accordance with yet another embodiment of the present invention;

FIG. 4 is diagram showing a logical test configuration, in accordance with an embodiment of the present invention;

FIG. 5 is a system diagram showing an automatic test recovery system, in accordance with an embodiment of the present invention;

FIG. 6 is a logical diagram showing an exemplary post mortem object, in accordance with an embodiment of the present invention;

FIG. 7 is a diagram showing an exemplary JavaSpaces storage space configuration;

FIG. 8 is a flowchart showing a method for restoring test execution after an unexpected crash in a DTF, in accordance with an embodiment of the present invention; and

FIG. 9 is a flowchart showing a method for restoring a test, in accordance with an embodiment of the present invention.

### DETAILED DESCRIPTION OF THE PREFERRED EMBODIMENTS

An invention is disclosed for restoring test execution after an unexpected crash in a distributed test framework. Embodiments of the present invention provide an ability to restore remote test execution from the point of interruption. As a result, a user can restart the execution of a test suite from the point where a crash has occurred. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

As used herein, an “ad-hoc” or a “dynamic” network is defined as a network in which the computer resources may be part of the network temporarily and for a specific length of time (i.e., spontaneous). In one example, the DPF system of the present invention implements the Jini™ (hereinafter “Jini”) technology to provide spontaneous interaction between its components. In this manner, the computer systems attach to and detach from the ad-hoc network of processing resources (e.g., computer resources) without disturbing the DPF system. Accordingly, the computer resources of the present invention are not limited to executing processes submitted to the DPF system of present invention.

DPF systems of the embodiments present invention can be distributed test framework (DTF) systems configured to manage test suite execution on cross-platform dynamically networked computer systems. In one implementation, the DTF system can include a server computer system and a plurality of ad-hoc network of processing resources configured to spontaneously interact implementing the Jini technology. The server computer system is configured to include a Jini look up service and a system controller configured to manage the processing of the submitted test suites. In one instance, the plurality of computer resources join the Jini look up service registering their respective proxies and the corresponding attributes. In one example, the system controller searches the look up service for an available suitable computer resource to process each of the submitted test suites. Once a computer resource is selected to run the test suite, the machine service component of the selected computer resource spawns a second service (e.g., process service) to execute the test suite.

As embodiments of the present invention can implement the Jini technology, a brief introduction to Jini is provided below. Nevertheless, this brief introduction to Jini should not be considered as limiting as Jini technology is well known by those skilled in the art. Jini technology is a network architecture that enables the spontaneous assembly and interaction of services and devices on a network of computer systems. Built on the Java platform, Jini technology eliminates the challenges of scale, component integration, and ad-hoc networking encountered in distributed computing environments. Jini simplifies interactions over a network by providing a fast and easy way for clients to use available services. Jini technology is also configured to be wire-protocol and transport-protocol neutral.

Summarily, Jini network technology includes a communication and programming model that enables clients and Jini services to discover and connect with each other to form an impromptu (i.e., spontaneous) Jini community. As Jini is written in Java, Jini implements the mechanism, Java Remote Method Invocation Application Program Interface (API), to move objects around the network.

In one embodiment, a Jini service is configured to employ a proxy to move around the network. As used herein, the proxy is defined as an object having service attributes and communication instructions. Through implementing discovery and join processes, the Jini services are found and thereafter registered with a look up service on a network. As used herein, registering a service is defined as sending the service proxy to all look up services on the network or a selected subset of the look up services. By way of example, the look up service is equivalent to a directory or an index of available services wherein the proxies for each of the services and their associated code are stored. When a service is requested, the proxy associated with the requested service is sent to the requesting client, thus enabling the client to use the requested service. Once dispatched, the proxy is configured to conduct all communication between the client and the Jini service.

In providing an ad-hoc network of computers, in one embodiment, Jini introduces a concept called “leasing.” That is, once a service joins the Jini network, the Jini service registers its availability for a certain period of leased time. This lease period may be renegotiated before the lease time is expired. When a service leaves the Jini network, the service entry in the look up service is removed automatically once the service's lease is expired. For further details on Jini technology, please refer to K. Arnold et al., The Jini Specification (1999) and W. Keith Edwards, Core Jini (1999).

As Jini is implemented in the Java™ (hereinafter “Java”) programming language, in a like manner, an overview of Java is provided below. In operation, a user of a typical Java based system interacts with an application layer of a system generally written by a third party developer. The application layer generally provides the user interface for the system. A Java module is used to process commands received by the application layer. A Java virtual machine is used as an interpreter to provide portability to Java applications. In general, developers design Java applications as hardware independent software modules, which are executed Java virtual machines. The Java virtual machine layer is developed to operate in conjunction with the native operating system of a particular hardware, which represents the physical hardware on which the system operates or runs. In this manner, Java applications can be ported from one hardware device to another without requiring updating of the application code.

Unlike most programming languages, in which a program is compiled into machine-dependent, executable program code, Java classes are compiled into machine independent byte code class files which are executed by a machine-dependent virtual machine. The virtual machine provides a level of abstraction between the machine independence of the byte code classes and the machine-dependent instruction set of the underlying computer hardware. A class loader is responsible for loading the byte code class files as needed, and an interpreter or just-in-time compiler provides for the transformation of byte codes into machine code.

More specifically, Java is a programming language designed to generate applications that can run on all hardware platforms, small, medium and large, without modification. Developed by Sun, Java has been promoted and geared heavily for the Web, both for public Web sites and intranets. Generally, Java programs can be called from within HTML documents or launched standalone. When a Java program runs from a Web page, it is called a “Java applet,” and when run on a Web server, the application is called a “servlet.”

Java is an interpreted language. The source code of a Java program is compiled into an intermediate language called “byte code.” The byte code is then converted (interpreted) into machine code at runtime. Upon finding a Java applet, the Web browser invokes a Java interpreter (Java Virtual Machine), which translates the byte code into machine code and runs it. Thus, Java programs are not dependent on any specific hardware and will run in any computer with the Java Virtual Machine software. On the server side, Java programs can also be compiled into machine language for faster performance. However a compiled Java program loses hardware independence as a result.

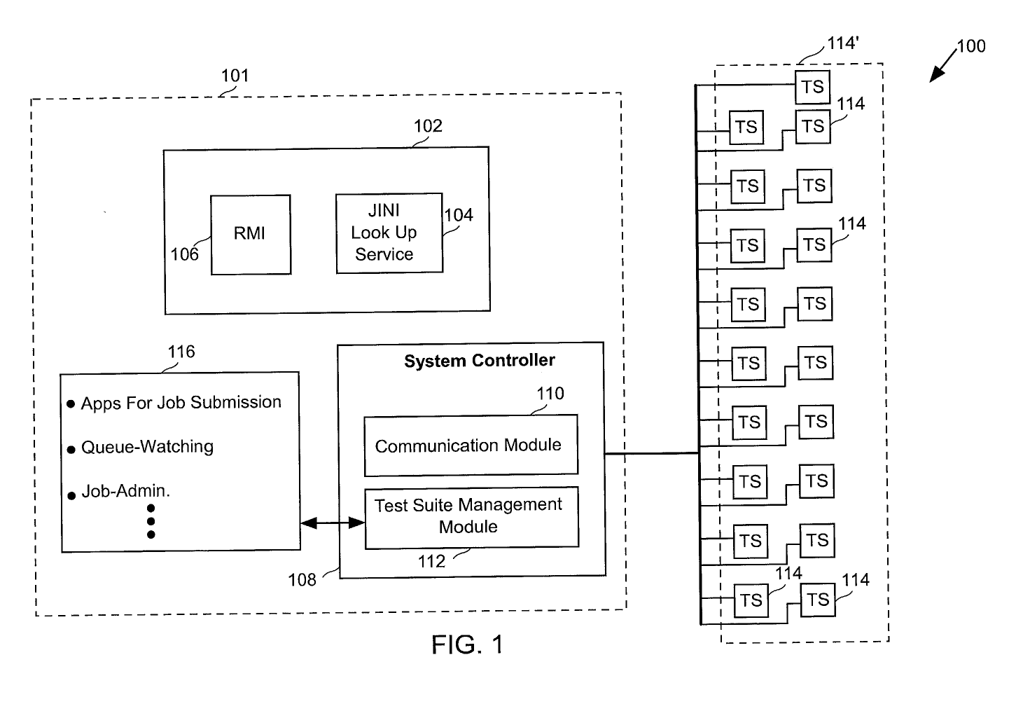

Keeping these brief overviews of Jini and Java as they relate to the embodiments of the present invention in mind, reference is now made to FIG. 1 illustrating a block diagram of a distributed test framework (DTF) system 100, in accordance with one embodiment of the present invention. As shown, physically, the DTF system 100 includes two groups of computer systems: (1) a system server group 101, and (2) a test system group 114′. The system server group 101 includes a service component 102 and a system controller 108. The service component 102 is configured to contain a Jini look up service 104 and a Remote Method Invocation (RMI) 106. In one embodiment, the RMI is designed to handle various communication needs. Comparatively, the Jini look up service 104 is a dedicated process running on the master computer system, server, and is configured to function as a central registry. As used herein, the master computer system is defined as the computer system running the system controller 108. As designed, in one embodiment, the master computer is configured to include both the system controller 108 and the service component 102. However, in a different implementation, each of the system controller 108 and the service component 102 may be included and run by separate computer systems. As designed, the look up service 104 is configured to enable the system controller 108 to locate available computer systems of an ad-hoc network of computer systems to execute a given test execution request using the test system registerable attributes. For instance, the look up service 104 includes registerable attributes, which identify the test machine platform, operating system, and other software and hardware characteristics.

The illustrated system controller 108 includes a communication module 110 and a test suite management module 112. The communication module 110 manages the communication between the system controller 108 and the distributed test systems 114. For instance, the communication module 110 is responsible for locating available test systems 114, running test execution requests, and gathering information regarding the status of the test systems 114. In one example, the system controller 108 manages the communication with the distributed test systems 114 by implementing a plurality of threads. In this manner, the system controller 108 has the capability to communicate with a plurality of test systems 114 in parallel. However, it should be noted that in other embodiments, the system controller 108 can implement any suitable mechanism to manage the communication between the system controller 108 and the distributed test systems 114 (e.g., Jini, RMI, TCP/IP Sockets, etc.).

The test suite management module 112 is responsible for managing the processing of the submitted test suites and the test execution requests. As used herein a test suite is a comprehensive list of data files having commands specifically programmed to initiate a number of functional aspects of the software product being tested. For instance, if the software product being tested is a word processing program, the test suite may activate a spell check command, a cut test command, a paste command, etc. Thus, once the test suite is executed, the test results reveal whether any of the tested commands failed to operate as intended. Also as used herein, once submitted for processing, each test suite becomes a “test execution request.” As the processing of different portions of the test suite can be assigned to different test machines, the test suites may be divided into a plurality of test execution requests (i.e., jobs).

By way of example, the test suite management module 112 maintains an inqueue directory designed to include almost all the submitted test execution requests. Once the system controller 108 is initiated, the system controller 108 is configured to read each test execution request from files held in the inqueue directory. Once a test execution request is read, it is put into either a wait queue configured to hold test execution requests waiting to be executed or an execution queue designed to hold test execution requests currently being executed. Further information regarding managing the inqueue directory, wait queue, and execution queue will be provided below. As illustrated, in one example, the test suite management module 112 is configured to manage the software applications and user interfaces implemented for job submission, queue watching, job administration, etc., as shown in 116.

The test system group 114′ includes a plurality of test systems 114 having similar or diverse hardware and software configuration. Although shown as a group, the test systems 114 are not necessarily limited to testing. In fact, the test systems 114 can be computers or systems used by employees of a company for normal desktop work. So long as the test systems 114 are associated with the networked group, the processing power of these test systems 114 can be used. In one embodiment, the test systems 114 can be used during normal working hours when the test systems 114 are running, for example, business applications, or during off hours, thus tapping into potentially huge processing resources that would otherwise be left unused. It should therefore be appreciated that test systems 114 do not necessarily have to be solely dedicated to testing or processing for the system server group 101.

In one embodiment, the test systems 114 are configured to execute the test execution requests dispatched by the system controller 108. Each of the test systems 114 runs an agent process (not shown in this Figure) designed to register the respective test system 114 with the Jini look up service 104. In this manner, the agent process for each test system 114 advertises the availability of the associated test system 114. As will be discussed in further detail below, a machine service component of the agent is used to establish communication between the associated test system 114 and the system controller 108. Specifically, by implementing the Jini attributes, the machine service registers the test system 114 characteristics with the Jini look up service 104. The test system 114 attributes are subsequently used by the system controller 108 to locate a test system 114 suitable to execute a specific test execution request.

While the DTF system 100 of the present invention can physically be divided into two groups, logically, the DTF system 100 of the embodiments of present invention comprises three over all components: (1) Job submission and other user interfaces; (2) Test scheduler and system controller; and (3) Test execution on remote or local systems.

For the most part, the job submission and other user interfaces component is a job queuing system having a variety of applications and user interfaces. As designed, the job submission component is configured to perform several tasks such as handling job submission, managing queues, administrating jobs, and administrating the ad-hoc network of the distributed test systems.

By way of example, in one implementation, the user interface may be as follows:

Launch system controller: In one embodiment, launching the system controller 108 is performed by running an appropriate shell script. As designed, the shell script is configured to launch the Jini and RMI support servers.

Kill system controller: Quit an appropriate shell script to destroy all the processes.

Submit jobs: Before the system controller 108 is launched, an Extensible Markup Language (XML) formatted test-execution-request file is created in the inqueue directory (e.g., that is preferably part of the test suite management module). In this manner, once the system Controller 108 is launched, the system controller 108 scans the inqueue directory, thus entering almost each and every test execution request into the in-queue (the in-queue being an actual queue, as contrasted with the inqueue directory).

Check queue: In one embodiment, a stopgap Graphical User Interface (GUI) is provided.

Cancel/administer a job: In one implementation, a stopgap GUI is implemented.

Other administrative tasks: In one exemplary embodiment, additional user interfaces are included. For instance, in certain cases, the system controller 108 is configured to implement various input files.

The second logical component, the test scheduler and system controller, includes the system controller 108 configured to perform the function of managing the job queues and dispatching the test execution requests to test system 114 for processing. Thus, the system controller 108 is configured to manage both; the wait queue (i.e., the queue containing the test execution requests waiting to be executed) and the execution queue (i.e., the queue containing test execution requests currently being executed). In one embodiment, the in-queue is analogous to the wait queue.

As designed, the test scheduler and system controller component is configured to include four modules:

Suite MGR: This module maintains a list of the available test suites stored in a known location in the file system. As designed, the test suite descriptions are stored in an XML formatted file in a suite directory.

Log MGR: This module is configured to handle the logging of activities inside the system controller 108 by implementing a plurality of log files having XML format. For instance, this is particularly useful for debug tracing and system statistics charting.

Queue MGR: This module is designed to maintain the two queues, wait queue (i.e., the in-queue) and the execution queue. Specifically, while a job is in any of the queues, an XML formatted file is kept in the queue directory reflecting the current status of the job. Each test execution request is configured to have a list of attributes describing the system characteristics required to execute the test execution request.

Scheduler: This module is configured to manage the dispatch of the test execution requests from the wait queue to the execution queue. In one embodiment, a job is dispatched when (a) the time to execute the job has been reached, and (b) a test system 114 having the required characteristics is available to execute the job.

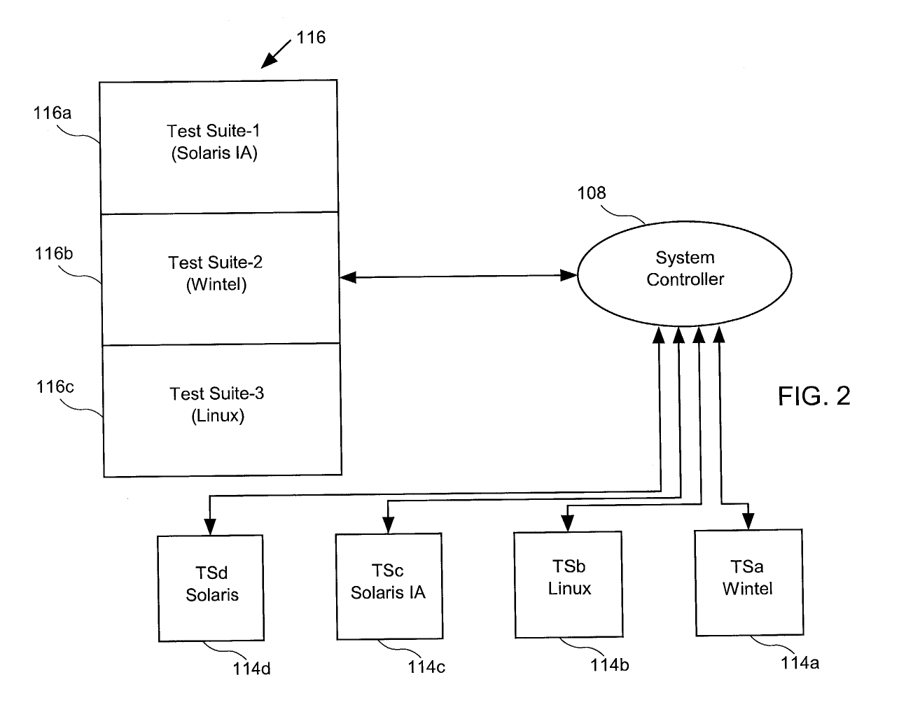

Reference is made to a block diagram depicted in FIG. 2 wherein the capability of the present invention to intelligently locate a test system 114 available to execute a test suite is illustrated, in accordance with one embodiment of the present invention. As shown, an inqueue directory 116 contains a plurality of test execution requests 116a, 116b, and 116c. In accordance with one embodiment of the present invention, once the system controller 108 is initiated, the system controller 108 is designed to read each test execution request 116a-116c contained within the inqueue directory 116. As shown, each test suite request 116a-116c must be executed by a test system 114 capable of running the test execution request requirements. For instance, each of the test execution requests 116a, 116b, and 116c must be run on a Solaris IA™ test system, a Wintel™ test system, or a Linux™ test system, respectively. The DTF system 100 of the present invention has the capability to advantageously locate an available test system from a plurality of ad-hoc network of test systems 114a, 114b, 114c, and 114d to execute each of the test execution requests 116a-116c.

As shown in the embodiment depicted in FIG. 2, each of the test systems 114a-114d has a different software and hardware configuration. For instance, while the test system 114a is run on Wintel™ and the test system 114b is run on Linux™, the test systems 114c and 114d are programmed to run on Solaris IA™ and Solaris™, respectively. As will be discussed in more detail below, the machine service for each test system 114a-114c registers the respective test system 114a-114c with the Jini look up service using the Jini attributes. Particularly, the embodiments of the present invention are configured to register the hardware and software configuration for each test system 114a-114d with the Jini look up service 104. In this manner, the system controller 108 can search the Jini look up service 104 implementing the test execution request requirements as search criteria. Thus, as shown in the example of FIG. 2, the system controller 108 of the present invention selects the test systems 114c, 114a, and 114b to execute the test suite requests 116a-116c, respectively.

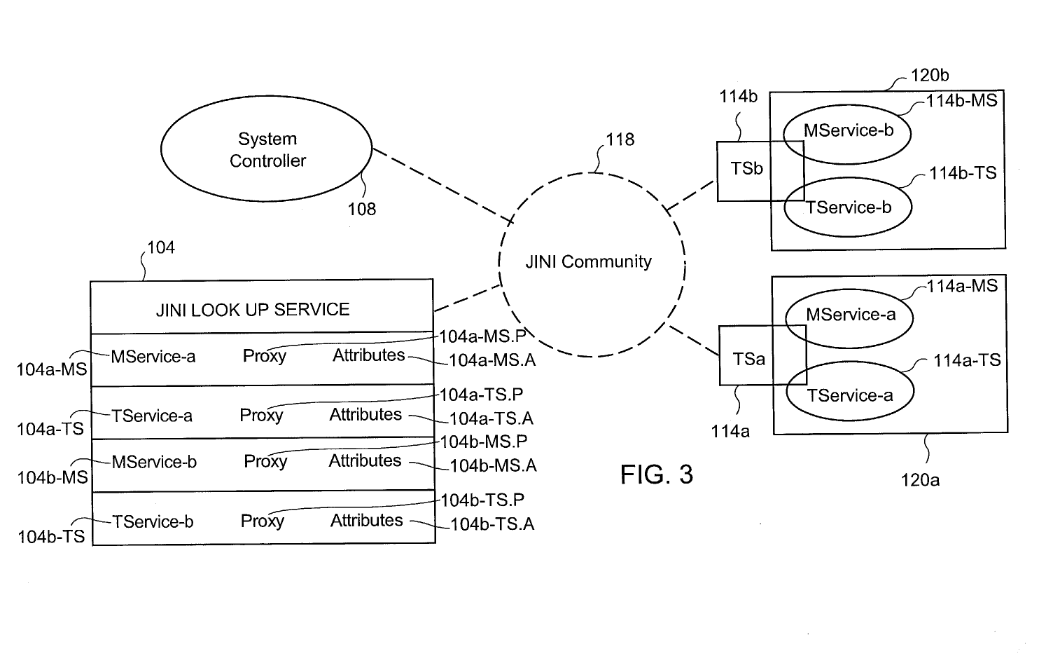

Implementing the test system attributes to locate a suitable test system to run a test execution request can further be understood with respect to the block diagram shown in FIG. 3, in accordance with one embodiment of the present invention. As shown, the test systems 114b and 114a, the system controller 108, and the Jini look up service 104 communicate to each other using Jini. In one example, the system controller 108, the Jini look up service 104, and the test systems 114a and 114b and all the other resources that are Jini enabled form a virtual Jini community 118.

As shown, the test system 114a runs an agent process 120a responsible for notifying the Jini look up service 104 of the existence and configuration of the test system 114a. In one example, the agent 120a is also designed to export a downloadable image of itself. Beneficially, the downloadable image allows the system controller 108 to ask the test system 114a to initiate running a test execution request while interacting with the test system 114a as the test execution request is being processed.

The illustrated agent 120a involves two Jini services, machine service 114a-MS and test service 114a-TS. The function of the machine service 114a-MS is to advertise the availability of the test system 114a, the characteristics of the test system 114a, and the ability of the test system 114a to launch a test execution request. Additionally, the machine service 114a-MS is designed to be present on the test machine 114a at all times. As such, the machine service 114a-MS is initiated on the test system 114a at the start-up time and is configured to remain active on the test system 114a until the test system 114ais shut down.

Comparatively, the test service 114a-TS is a module configured to encapsulate the test execution request. As designed, the test service 114a-TS is spawned by the machine service 114a-MS and is subsequently launched when the machine service 114a-MS receives a request to start running a test execution request from the system controller 108. Specifically, the new test service 114a-TS is spawned based on the test execution request type. By way of example, in one embodiment, the machine service 114a-MS spawns separate test systems 114a-TS when running Tonga-type, JCK-type, JTREG-type, and shell-type test suites. However, one having ordinary skill in the art must appreciate that in a different example, the machine services of the DTF system of the present invention are configured to spawn other suitable test systems. As shown, similar to test system 114a, the test system 114b is configured to include an agent 120b designed to include a machine system 114b-MS and a test system 114b-TS.

As will be discussed in greater detail below and as shown in the implementation of FIG. 3, the machine service 114a-MS and test service 114a-TS, respectively, register Jini attributes 104a-MS.A and 104a-TS.A of the test system 114a with the Jini look up service 104. For instance, in one embodiment, the sequence of events in registering the machine service 114a-MS and test service 114a-TS may be as follows: Once the test-system 114a discovers and joins the Jini community 118, the test service 114a-MS of the test system 114a registers with the Jini look up service 104. In this manner, the machine service 114a-MS registers a machine service proxy 104a-MS.P and the attributes 104a-MS.A of the machine service 114a-MS with the look up service 104. The Jini attributes 104a-MS.A are then used by the system controller 108 to locate a test service having attributes suitable to run the test execution request.

Once the test system 114a has been selected to run the test execution request, the machine service 114a-MS spawns a test service 114a-TS having the same type as the test execution request. As discussed above, the machine service 114a-MS is configured to spawn a matching test service 114a-TS for each test execution request type. For example, the test system 114a may have the attributes to run a Tonga test execution request and a JTREG type test execution request. In such a situation, the Jini look up service 104 will include two test services each running a different type of test execution request. As a consequence, when the processing of one type of test execution request has concluded, the test service 114a-TS having substantially the same type can be terminated. Thus, for the most part, the test service 104a-TS, 104a-TS.A, and 104-TS.P are designed to substantially exist while the test system 114a is running a test execution request. In this manner, the system controller 108 can determine whether the test system 114a is processing a test execution request. Specifically, this is achieved by the system controller 108 simply querying the Jini look up service 104 as to whether the test system 114a has an associated existing test service.

In addition to registering the attributes 104a-MS.A and 104a-TS.A, the machine service 114a-MS and the test system 114a-TS are configured to respectively register a corresponding machine service proxy 104-MS.P and a respective test service proxy 104-TS.P with the Jini look up service 104. As designed, the system controller 108 implements the machine service proxy 104-MS.P and the test service proxy 104-TS.P to communicate with the test system 114a. Particularly, once the system controller 108 has selected the test system 114a to run the test execution request, the system controller 108 downloads the machine service proxy 104-MS.P from the Jini look up service 104. Once the machine service proxy 104-MS.P is downloaded, the system controller 108 starts communicating with the machine service proxy 104-MS.P rather than communicating directly with the corresponding test system 114a or the machine service 114a-MS.

In a like manner, the test service proxy 104-TS.P is the communication channel between the system controller 108 and the test service 114a-TS. Thus, similar to the machine service 114a-MS, the system controller 108 downloads the test service proxy 104-TS.P from the Jini look up service 104. Thereafter, the system controller communicates with the test service proxy 104-TS.P as if communicating with the test system 114a or the test service 114a-TS. As shown, in the same manner, the machine service 114b-MS and test service 114b-TS register their respective machine service proxy 104b-MS.P and machine service attributes 104b-MS.A as well as the respective test service proxy 104b-TS.P and test service attributes 104b-TS.A with the Jini look up service 104. Further information on DPF system operation can be found in parent U.S. patent application Ser. No. 09/953,223, filed Sep. 11, 2001, and entitled “Distributed Processing Framework System,” which is incorporated herein by reference.

In addition to providing efficient access to remote resources, embodiments of the present invention provide an ability to restore remote test execution after the test has been interrupted. As a result, a user can restart the test suite from the point where the interruption occurred. As will described in greater detail subsequently, embodiments of the present invention record the current execution point within a test suite on a regular basis. This record can then be used to restore test execution from the point of interruption.

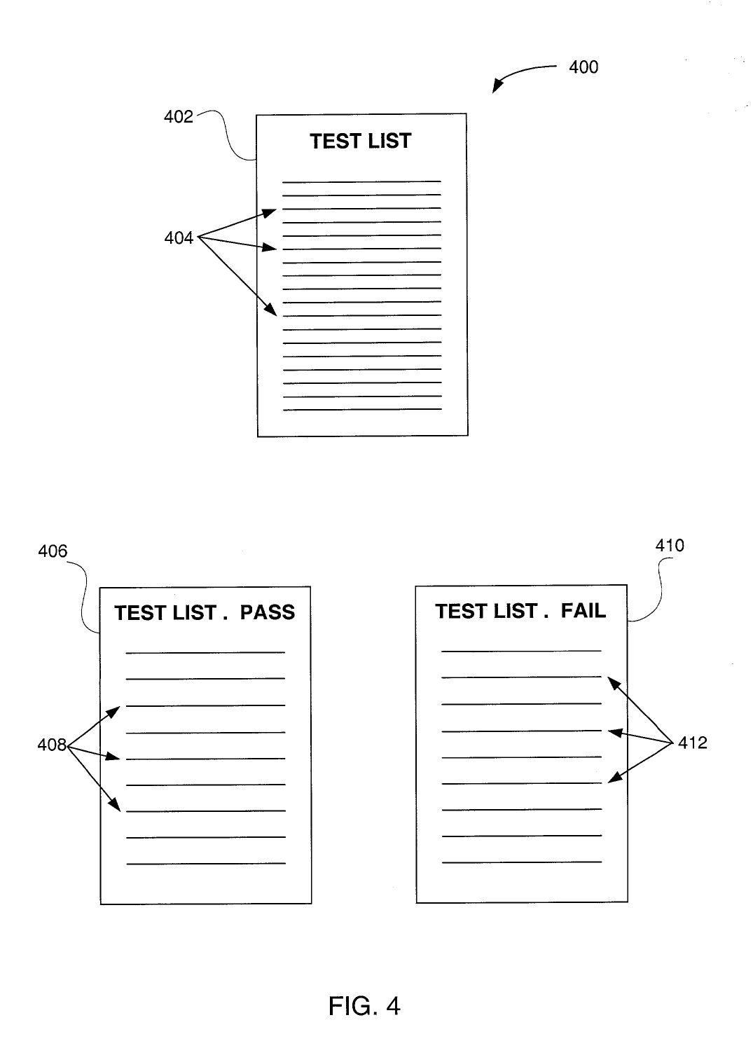

FIG. 4 is diagram showing a logical test configuration 400, in accordance with an embodiment of the present invention. The test configuration 400 includes a test suite comprising a test list 402 having a plurality of individual tests 404. During execution, a test harness executes the individual tests 404 within the test list 402. When each individual test 404 completes execution, a determination is made as to whether the particular individual test 404 passed or failed.

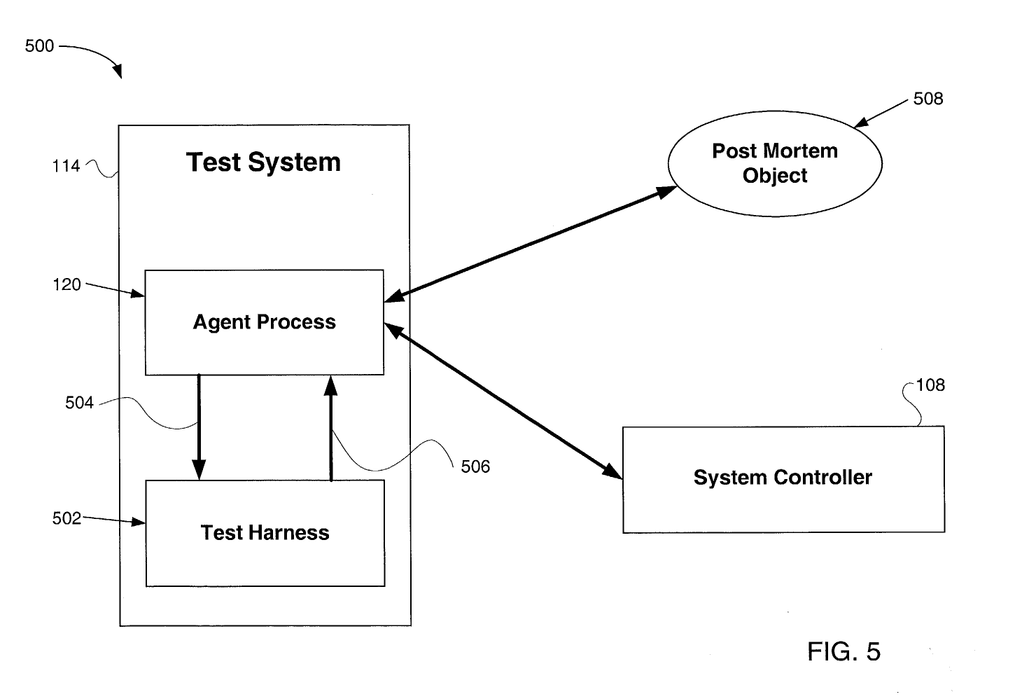

Tests 404 that pass are listed in a tests pass file 406, while tests 404 that fail are listed in a tests fail file 410. Hence, the tests pass file 406 includes a plurality of passed tests results 408 and the tests fail file 410 includes a plurality of failed tests results 412. After test execution, the test harness can read the test results files 406 and 410 and report the results to the test engineer, generally via the system controller. However, for a variety of reasons, the test harness can crash during execution. For example, the test system on which the test harness is executing may fail, or the test harness itself may fail to execute properly and crash as a result. In any case, embodiments of the present invention provide a mechanism for recovery from the point of the crash. In particular, embodiments of the present invention utilize a post mortem object to record the current execution information on a periodic basis, as explained next with reference to FIG. 5.

FIG. 5 is a system diagram showing an automatic test recovery system 500, in accordance with an embodiment of the present invention. The automatic test recovery system 500 includes a system controller 108 in communication with an agent process 120 executing on a test system 114. The agent process 120 is further in communication with a test harness 502, which executes a plurality of tests of a test suite. As will be apparent to those skilled in the art, a test harness 502 typically comprises an application that executes a test suite and includes the ability to report the test results for the tests it executes.

As described above, during operation the agent process 120 launches the test harness 502, which proceeds to execute the plurality of tests comprising a test suite. Tests that pass are listed in a tests pass file, while tests that fail are listed in a tests fail file. Hence, the tests pass file includes a plurality of passed tests results and the tests fail file includes a plurality of failed tests results. After test execution, the test harness can read the test results files and report the results to the test engineer, generally via the system controller 108. To facilitate test restoration after a crash, embodiments of the present invention periodically store test execution information using a post mortem object 508.

Periodically the agent process 120 sends an information request 504 to the test harness 502 requesting test execution information. Among other data, the requested test execution information includes the current point of execution in the test suite. The information request 504 is sent at a predetermined interval, which can be set to any particular time interval as desired by the test engineer. Generally, when the time interval between information requests 504 is small, the point of crash can be determined with greater accuracy. On the other hand, when the time interval between information requests 504 is large, less processing is needed because fewer information requests 504 will be sent during any particular test harness execution. Hence, the test engineer or system developer can set the time interval between information requests 504 to any time interval as needed for the particular system.

In response to receiving the information request 504, the test harness 502 provides the test execution information 506 to the agent process 120. As mentioned above, the test execution information 506 includes the current point of execution within the suite. As a result, the agent process can determine which tests are currently executing. To facilitate the two-way communication between the test harness 502 and the agent process 120, embodiments of the present invention can utilize a user design service (UDS). The UDS is an interface configuration, which allows two-way communication between an agent process and a launched application. As a result, the UDS allows enhanced test execution management. Further information regarding the UDS can be found in U.S. application Ser. No. ______ (Attorney Docket No. SUNMP030), filed Nov. 20, 2001, and entitled “Methods to Develop Remote Applications with Built in Feedback Ability for Use in a Distributed Test Framework,” which is incorporated herein by reference.

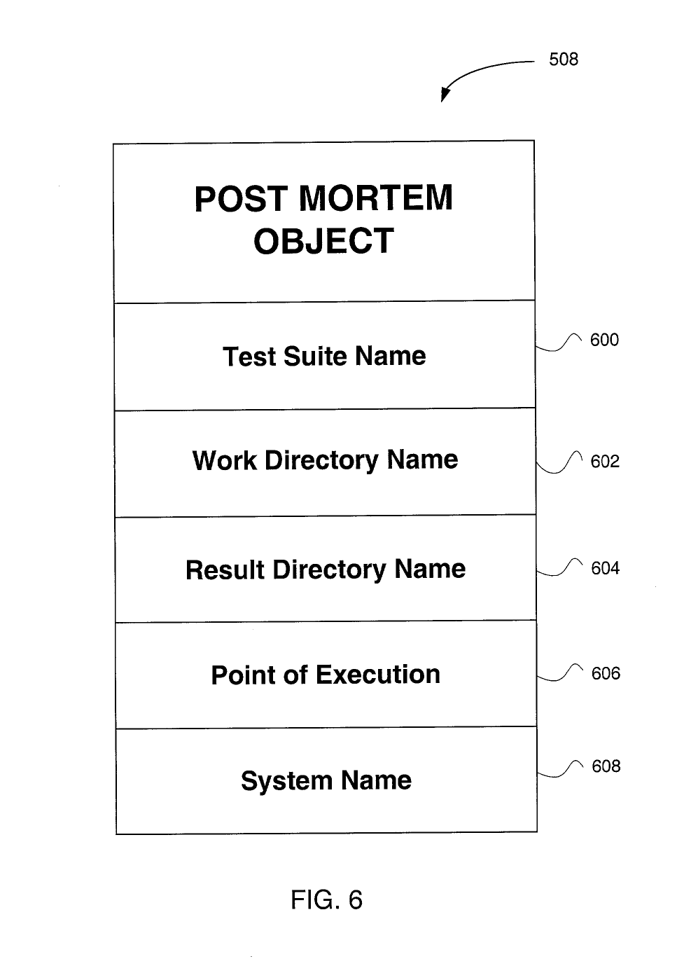

Upon receiving the test execution information 506 from the test harness 502, the agent process 120 updates a post mortem object 508, which includes information regarding the test suite executed by the test harness 502. In particular, the post mortem object 508 stores information such as the particular test harness being executed, where it is being executed, and the current point of execution within the test suite. The information stored within the post mortem object 508 for the particular test harness 502 is updated when the agent process 120 receives new test execution information 506. For example, upon receiving the test execution information 506 from the test harness 502, the agent process updates the post mortem object 508, including updating the current execution point of the test suite. In this manner, the post mortem object 508 stores a periodically updated record of the test suite execution for a particular test harness 502, as explained in greater detail subsequently with respect to FIG. 6.

As mentioned above, agent processes 120 of the embodiments of the present invention typically registers its availability for a certain period of leased time on the look up service. When for the agent process 120 expires, the system controller 108 is notified. As a result, the system controller can determine when the execution of a particular test harness 502 has been interrupted. More particularly, if the test results for the test harness 502 are not complete when the system controller 108 is notified of the expiration of the agent process 120 lease, the test suite has been interrupted. In response, the system controller 108 can send a request to the agent process 120 to restore the test harness 502.

Upon receiving a request to restore the test harness 502, the agent processes 120 refers to the storage space, typically JavaSpaces™ as described in greater detail subsequently, and identifies the post mortem object 508 corresponding to the failed test harness 502. The agent process 120 then downloads the post mortem object 508 and uses the information stored in the post mortem object 508 to reinitialize the test harness 502. Specifically, the agent process 120 uses the point of execution stored in the post mortem object 508 to reinitialize the test harness 502 to the point of execution stored in the post mortem object 508. Hence, the test harness 502 is reinitialized to the point of execution stored in the post mortem object 508 during the last update before interruption.

FIG. 6 is a logical diagram showing an exemplary post mortem object 508, in accordance with an embodiment of the present invention. As shown in FIG. 6, the exemplary post mortem object 508 can include a plurality of data fields 600-608. These data fields can include the test suite name 600, the work directory name 602, the result directory name 604, the point of execution 606, and the system name 608. It should be noted that the data fields listed in the exemplary post mortem object 508 are listed for exemplary purposes. In implementation, a post mortem object 508 of the embodiments of the present invention can include any number and type of data fields, as desired by the system developer or test engineer.

The test suite name data field 600 lists the name of the test suite that the test harness is executing. As mentioned previously, a test suite comprises a plurality of individual tests, which are executed and the results recorded. The work directory name data field 602 list the name of the directory where the test harness is located. Hence, the work directory name data field 602 provides the agent process with an indication of where to locate the test harness. The result directory name data field 604 lists the name of the directory where the test results are stored. Typically the test results comprise a pass test file listing individual tests that pass, and a fail test file listing individual tests that fail.

The point of execution data field 606 stores the point of execution of the test suite during the last update to the post mortem object 508. As mentioned above, the agent process can download the post mortem object 508 and use the point of execution data field 606 to reinitialize the test harness. Specifically, the agent process can use the point of execution data field 606 to reinitialize the test harness to the point of execution stored in the post mortem object 508 during the last update before execution of the test harness was interrupted. The system name data field 608 lists the name of the test system on which the test harness was executing. Thus, the agent process can use the system name data field 608 to reinitialize the test harness on the same test system on which it was executing prior to being interrupted.

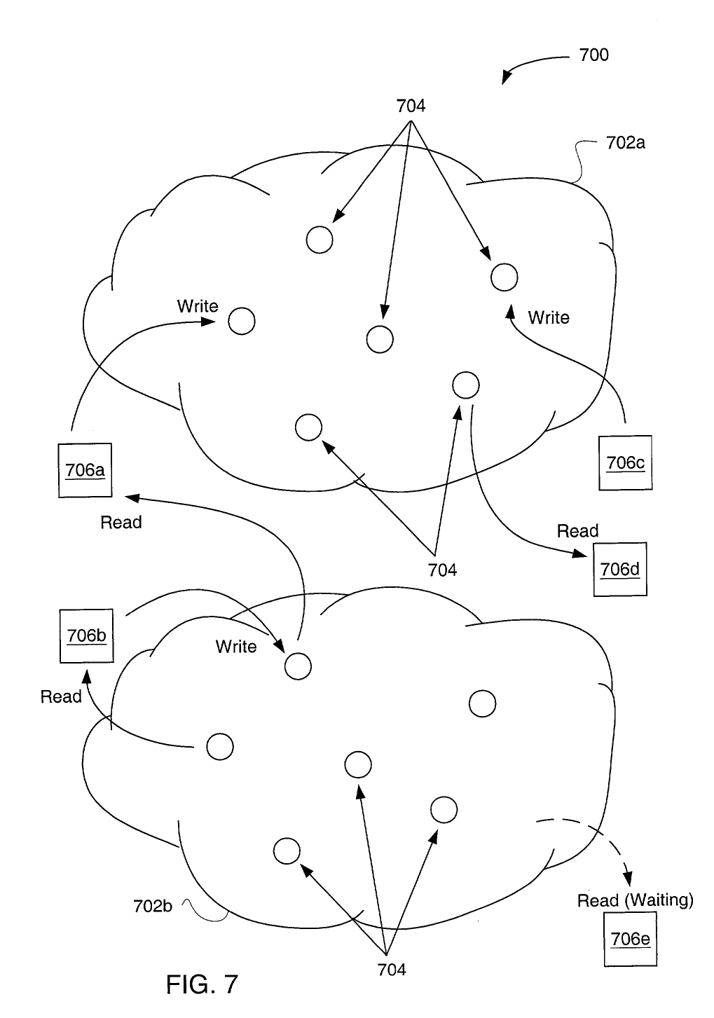

As mentioned above, embodiments of the present invention typically store post mortem objects using JavaSpaces™ (hereinafter “JavaSpaces”). FIG. 7 is a diagram showing an exemplary JavaSpaces storage space configuration 700. The exemplary JavaSpaces storage space configuration 700 includes a plurality of Java Spaces 702a and 702b, each storing a plurality of data objects 704. Each Java Space 702a and 702b can comprise any storage system, including a plurality of networked storage systems located locally, remotely, or both.

JavaSpaces is a unified mechanism for dynamic communication, coordination, and sharing of objects between Java technology-based network resources, such as agent processes and system controllers. In a distributed application, JavaSpaces technology acts as a virtual space between providers and requesters of network resources or objects. This allows participants in a distributed solution to exchange tasks, requests and information in the form of Java technology-based objects. JavaSpaces technology provides developers with the ability to create and store objects with persistence, which allows for process integrity.

Hence, a plurality of processing resources 706a-706e can share stored data in the exemplary JavaSpaces storage space configuration 700. For example, as shown in FIG. 7, processing resource 706b can write an object 704 to Java Space 702b, which can then be read by processing resource 706a. Processing resource 706a can then write the object 704 to Java Space 702a. Further, processing resources can request objects 704 from the exemplary JavaSpaces storage space configuration 700 that may not be currently available. For example, processing resource 706e can request a particular object 704 from the exemplary JavaSpaces storage space configuration 700. If the requested object 704 is not currently available, processing resource 706e can wait for the object 704 to become available. In this manner, post mortem objects of the embodiments of the present invention can be stored on a JavaSpaces network and accessed generally without regard to where the post mortem object is physically located.

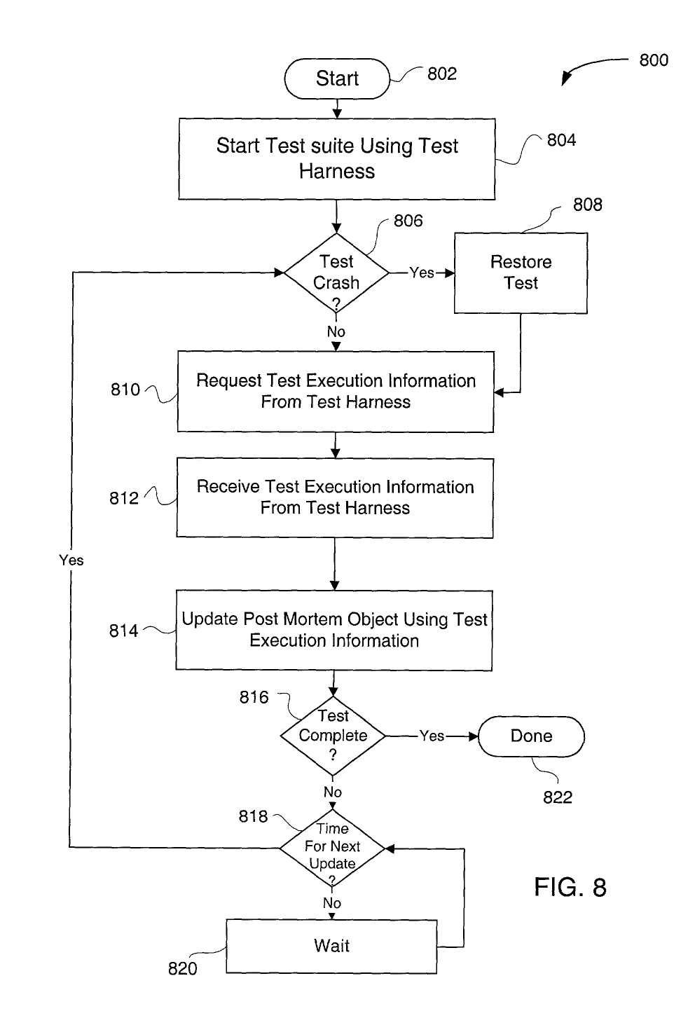

FIG. 8 is a flowchart showing a method 800 for restoring test execution after an unexpected crash in a DTF, in accordance with an embodiment of the present invention. In an initial operation 802, preprocess operations are performed. Preprocess operations can include sending a test execution request, selecting an agent to perform the test execution request based on the attributes of the related test system, launching the test harness, and other preprocess operations that will be apparent to those skilled in the art.

In operation 804, the test harness starts the test suite. As mentioned above, a test suite comprises a test list having a plurality of individual tests. During execution, the test harness executes the individual tests within the test list, and determines whether each individual test passed or failed. Tests that pass are listed in a tests pass file, while tests that fail are listed in a tests fail file. Hence, the tests pass file includes a plurality of passed tests results and the tests fail file includes a plurality of failed tests results.

A decision is then made as to whether the test harness has crashed, in operation 806. For a variety of reasons, the test harness can crash during execution. For example, the test system on which the test harness is executing may fail, or the test harness itself may fail to execute properly and crash as a result. If the test harness has crashed, the method 800 branches to operation 808. Otherwise, the method 800 continues to operation 810.

In operation 810, the agent process requests test execution information from the test harness. Periodically the agent process sends an information request to the test harness requesting test execution information. Among other data, the requested test execution information includes the current point of execution in the test suite. As will be explained in greater detail subsequently, the information request is sent at a predetermined interval, which can be set to any particular time interval as desired by the test engineer.

The agent process then receives the test execution information from the test harness, in operation 812. In response to receiving the information request, the test harness provides the test execution information to the agent process. As mentioned above, the test execution information includes the current point of execution within the suite. As a result, the agent process can determine which tests are currently executing. To facilitate the two-way communication between the test harness and the agent process, embodiments of the present invention can utilize a user design service (UDS). The UDS is an interface configuration, which allows two-way communication between an agent process and a launched application. As a result, the UDS allows enhanced test execution management.

In operation 814, the agent process updates the post mortem object using the received test execution information. Upon receiving the test execution information from the test harness, the agent process updates a post mortem object. As mentioned above, the post mortem object includes information regarding the test suite executed by the test harness. In particular, the post mortem object stores information such as the particular test harness being executed, where it is being executed, and the current point of execution within the test suite. Hence, the post mortem object stores a periodically updated record of the test suite execution from a particular test harness.

A decision is then made as to whether the test harness has completed execution, in operation 816. If the test harness has completed execution, the method 800 completes in operation 822. Otherwise, the method 800 continues to operation 818. In operation 818, a decision is made as to whether the next update time has been reached. As mentioned above, embodiments of the present invention update the post mortem object on a periodic basis. If the next update time has been reached, the method 800 loops to operation 806, and continues to periodically update the post mortem object. Otherwise, the method 800 continues to operation 820.

In operation 820, the agent process waits for a predetermined period of time. The information request is sent at a predetermined interval, which can be set to any particular time interval as desired by the test engineer. Generally, when the time interval between information requests is small, the point of crash can be determined with greater accuracy. When time interval between information requests is large, less processing is needed because fewer information requests will be sent during any particular test harness execution. Hence, the test engineer or system developer can set the time interval between information requests to any time interval as needed for the particular system.

Post process operations are performed in operation 822. Post process operations include reporting the test suite results, advertising the availability of the test system for further test processing, and other post process operations that will be apparent to those skilled in the art after a careful reading of the present description. In this manner, the embodiments of the present invention periodically update and store the current point of execution, which allows test restoration in the event of a crash.

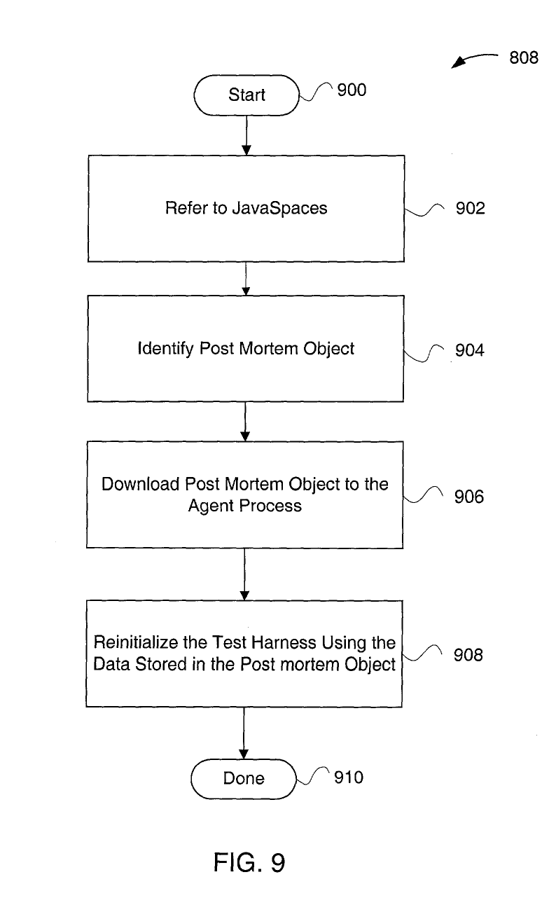

FIG. 9 is a flowchart showing a method 808 for restoring a test harness, in accordance with an embodiment of the present invention. Preprocess operations are performed in operation 900. Preprocess operations can include determining the test harness has been interrupted, sending a request to restore the test harness from the system controller, and other preprocess operations that will be apparent to those skilled in the art after a careful reading of the present disclosure.

In operation 902, the agent process refers to the JavaSpace for the system. As mentioned above, JavaSpaces is a unified mechanism for dynamic communication, coordination, and sharing of objects between Java technology-based network resources, such as agent processes and system controllers. In a distributed application, JavaSpaces technology acts as a virtual space between providers and requesters of network resources or objects. This allows participants in a distributed solution to exchange tasks, requests and information in the form of Java technology-based objects. JavaSpaces technology provides developers with the ability to create and store objects with persistence, which allows for process integrity.

The agent process then identifies the post mortem object corresponding to the test harness to be restored, in operation 904. A separate post mortem object can be maintained for each test harness executed in the network test environment. Each post mortem object can include data fields identifying the object to a particular test system, test suite, working directory, and result directory, as described above with reference to FIG. 6.

In operation 906, the agent process downloads the post mortem object from storage. As previously mentioned, embodiments of the present invention store the post mortem objects using JavaSpaces technology. Hence, the physical location of the post mortem object generally does not impact the agent process load. As a result, embodiments of the present invention can download post mortem objects generally from any location on the network in an efficient non-complex manner.

The agent process reinitializes the test harness, in operation 908, using the data stored in the post mortem object. The agent process uses the point of execution stored in the post mortem object to reinitialize the test harness to the point of execution stored in the post mortem object. Hence, the test harness is reinitialized to the point of execution stored in the post mortem object during the last update before interruption of the test harness. Post process operations are then performed in operation 910. Post process operations can include requesting execution information from the restored test harness, updating the post mortem object for the restored test harness, and other post process operations that will be apparent to those skilled in the art after a careful reading of the present description.

While the above described invention has been described in the general context of an application program that is executed on an operating system in conjunction with a test system, it should be appreciated that the invention may be implemented with other routines, programs, components, data structures, etc., which perform particular tasks or implement particular abstract data types. Furthermore, the invention may be practiced with other computer system configurations including hand-held devices, microprocessor systems, microprocessor-based or programmable consumer electronics, minicomputers, mainframe computers and the like.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system for restoring execution of an application program after interruption in a distributed processing framework, comprising:
a post mortem object storing point of execution information for an application program, wherein the point of execution information is periodically updated to reflect a current point of execution within the application program at a time of the update; and
an agent process executing on a processing resource, wherein the agent process is capable of utilizing the post mortem object to reinitialize the application program to begin execution from a position described by the point of execution information.

2. A system as recited in claim 1, wherein the agent process sends an information request to the application program requesting execution information.

3. A system as recited in claim 2, wherein the application program returns execution information to the agent process in response to receiving the information request.

4. A system as recited in claim 3, wherein the execution information includes the current point of execution within the application program.

5. A system as recited in claim 4, wherein the application program is a test harness that executes a plurality of individual tests.

6. A system as recited in claim 5, wherein the point of execution refers to an individual test of the test harness that was most recently executed.

7. A system as recited in claim 6, wherein the agent process updates the post mortem object with an indication of the individual test referred to by the point of execution.

8. A system as recited in claim 7, wherein the agent process can reinitialize the test harness to begin execution from a particular individual test specified in the post mortem object.

9. A method for restoring execution of an application program after interruption in a distributed processing framework, comprising:
providing an agent process in communication with an application program;
updating a post mortem object using the agent process, wherein the agent process updates the post mortem object based on a current point of execution within the application program; and
reinitializing the application program after interruption of the application program utilizing the post mortem object.

10. A method as recited in claim 9, further comprising the operation of sending an information request from the agent process to the application program.

11. A method as recited in claim 10, further comprising the operation of sending execution information from the application program to the agent process in response to receiving the information request.

12. A method as recited in claim 11, wherein the execution information includes a current point of execution within the application program.

13. A method as recited in claim 12, wherein the application is a test harness that executes a plurality of individual tests.

14. A method as recited in claim 13, wherein the point of execution refers to an individual test of the test harness that was most recently executed.

15. A method as recited in claim 14, further comprising the operation of updating the post mortem object with an indication of the individual test referred to by the point of execution.

16. A method as recited in claim 15, further comprising the operation reinitializing the test harness to begin execution from a particular individual test specified in the post mortem object.

17. A computer program embodied on a computer readable medium for restoring execution of an application program after interruption in a distributed processing framework, the computer program comprising:
a code segment that receives execution information from an application program, wherein the execution information includes a current point of execution within the application program;
a code segment that updates a post mortem object based on the execution information; and
a code segment that reinitializes the application program utilizing the post mortem object after interruption of the application program.

18. A computer program as recited in claim 17, wherein the application is a test harness that executes a plurality of individual tests, and wherein the point of execution refers to an individual test of the test harness that was most recently executed.

19. A computer program as recited in claim 18, wherein the post mortem object is updated with an indication of the individual test referred to by the point of execution.

20. A post mortem object as recited in claim 19, wherein the test harness is reinitialized to begin execution from a particular individual test specified in the post mortem object.
